(19) United States
(12) Patent Application Publication
(10) Pub. No.: US 2011/0147492 A1
(43) Pub. Date: Jun. 23, 2011

(54) HOSE

(75) Inventor: Richard J. Gilpatrick, Whitewater, WI (US)

(73) Assignee: Briggs & Stratton Corporation, Wauwatosa, WI (US)

(21) Appl. No.: 12/641,320

(22) Filed: Dec. 17, 2009

(51) Int. Cl. B05B 9/01; B23P 11/00

(52) U.S. Cl. 239/526; 138/115; 29/428

(57) ABSTRACT

A hose includes a first tubular core, a second tubular core, a reinforcement and a jacket. The first tubular core has a first conduit opening into a first passage at a first end of the first conduit and opening into a second passage at a second end of the first conduit. The second tubular core has a second conduit opening into the first passage at a first end of the second conduit and opening into the second passage at a second end of the second conduit. The reinforcement is sandwiched between the first tubular core and the second tubular core. The jacket extends about and interconnects the first tubular core and the second tubular core.

### BACKGROUND

Hoses are sometimes used to deliver fluid under high pressures. Such hoses are often subject to kinking and occupy a large amount of space when wound upon a reel or other storage structure.

### BRIEF DESCRIPTION OF THE DRAWINGS

FIG. 1 is a top perspective view of a fluid delivery system having a hose assembly according to an example embodiment.

FIG. 2 is an enlarged fragmentary view of the hose assembly of FIG. 1.

FIG. 3 as a sectional view of the hose assembly of Figure taken along line 3-3.

FIG. 4 is a perspective view of a hose of the hose assembly of FIG. 2 with portions removed for purposes of illustration.

FIG. 5 is a sectional view of the hose of FIG. 4 taken along line 5-5.

FIG. 6 is an exploded perspective view of a portion of the hose assembly of FIG. 2. FIG. 6A is a sectional view of a hose coupler of the hose assembly of FIG. 6.

FIG. 7 is a sectional view of a first alternative embodiment of the hose of FIG. 1.

FIG. 8 is a sectional view of a second alternative embodiment of the hose of FIG. 1.

FIG. 9 is a sectional view of a third alternative embodiment of the hose of FIG. 1.

FIG. 10 is a sectional view of a fourth alternative embodiment of the hose of FIG. 1.

FIG. 11 is a sectional view of a fifth alternative embodiment of the hose of FIG. 1.

FIG. 12 is a sectional view of a sixth alternative embodiment of the hose of FIG. 1.

FIG. 13 is a sectional view of a seventh alternative embodiment of the hose of FIG. 1.

### DETAILED DESCRIPTION OF THE EXAMPLE EMBODIMENTS

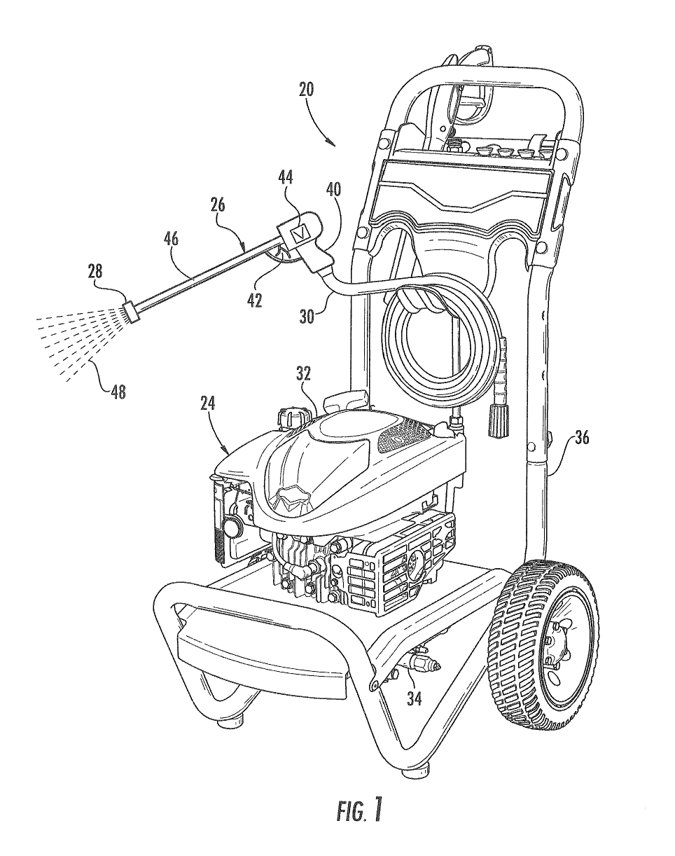

FIG. 1 illustrates a fluid delivery system (shown as a fluid sprayer 20) according to an example embodiment. Fluid sprayer 20 delivers fluid under relatively high pressures such as pressures greater than or equal to about 100 pounds per square inch (PSI) at a discharge point. As will be described hereafter, fluid sprayer 20 includes a hose construction that accommodates such high-pressure fluids, that may be less susceptible to kinking and that may be more compact and result in a smaller coil when wound up for storage.

Fluid sprayer 20 includes a source of pressurized fluid 24, an emitting wand or spray gun 26 having a nozzle tip 28 and a hose assembly 30 connecting pressurized fluid source 24 and spray gun 26. Pressurized fluid source 24 pressurizes fluid (liquid, gas or a combination thereof) and supplies a fluid to spray gun 26 which directs pressurized fluid through nozzle 28. Pressurized fluid source 24 delivers fluid set to have a pressure at a discharge point of nozzle 28 of at least 100 pounds per square inch (PSI) (at least a Type 1 power washer). In the example illustrated, pressurized fluid source 24 comprises an internal combustion engine 32 which drives a fluid pump 34 to pressurize water (and potentially additional additives). According to one embodiment, the pump 34 comprises a pump at least similar to the pump shown and described in U.S. Pat. No. 6,092,998 to Dexter et al. which issued on Jul. 25, 2000, the full disclosure of which is hereby incorporated by reference. The internal combustion engine 32 and the pump 34 are supported by a stand 36. In other embodiments, the internal combustion engine 32, the pump 34 and the stand 36 may have other configurations.

Spray gun 26 is fluidly connected to pump 34 by hose 30 and receive pressurized fluid from pump 34. Spray gun 26 comprises handle 40, trigger 42, valve 44, barrel 46 and nozzle 28. Handle 40 facilities gripping of spray gun 26. Trigger 42 comprises a manually actuatable trigger operatively connected to valve 44 to selectively open and close valve 44. Valve 44, schematically shown, actuates between a fully closed state and a fully open state in response to depressment, pivoting or other actuation of trigger 44. Valve 44 regulates the flow of the pressurized fluid to barrel 46. Barrel 46 delivers the pressurized fluid to nozzle 28 which emits the fluid 48. In other embodiments, spray gun 26 may have other configurations and may operate in alternative fashions.

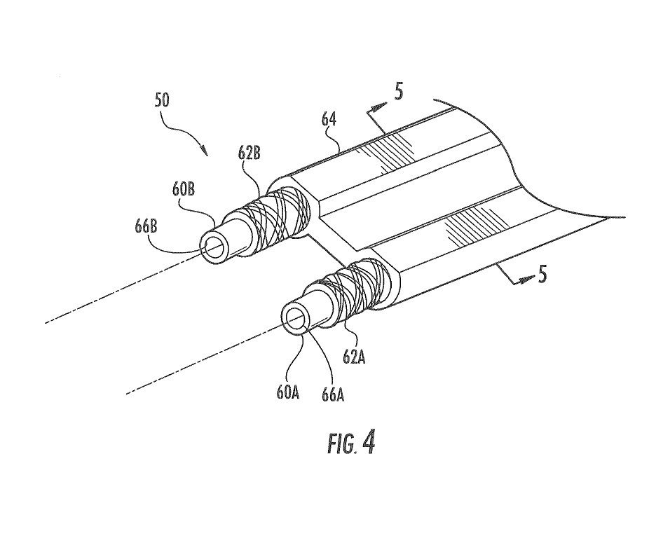

Hose assembly 30 delivers pressurized fluid from pump 34 to spray gun 26. FIGS. 2-6 illustrate one example of hose assembly 30. As shown by FIG. 2, hose assembly 30 includes hose 50, inlet hose connector 52 and outlet hose connector 54. Hose 50 extends between and fluidly interconnects hose connectors 52, 54. In particular, hose 50 has a first end 56 connected to inlet connector 52 and a second opposite and 58 connected to outlet connector 54. As shown by FIGS. 4 and 5, hose 50 includes cores 60A, 60B (collectively referred to as cores 60), reinforcements 62A, 62B (collectively referred to as reinforcements 62) and jacket 64.

Cores 60 comprise elongate tubular members or tubes formed from one or more flexible materials and providing conduits 66A and 66B (collectively referred to as conduits 66). Conduits 66 comprise individual fluid passageways which are isolated from one another along a majority, if not substantially the entire length, of hose 50. The fluid passages provided by conduits 66 merge or join into a single volume, chamber or a single fluid passage at both opposite ends of conduits 66 (also at opposite ends of hose 50). As a result, fluid traveling through cores 66 is mixed both before entering hose 60 as well as after being discharged from hose 60. According to one embodiment, cores 66 connect to a same volume provided by inlet hose connector 52 at one end and connect to a same volume provided by outlet hose connector 54 at another opposite end.

Cores 60, together, provide a collective passageway cross-section sufficiently large to deliver a sufficient volume of high-pressure fluid to spray gun 26 so as to achieve the desired pressure at nozzle 28 of spray gun 26. As shown by FIG. 5, each of cores 60 has an internal radius of between about 2.25 mm and 2.33 mm and an outer radius of between about 3.75 mm and 3.83 mm. In yet other embodiments, cores 60 may have other dimensions.

In the example illustrated, each of cores 60 is formed from polyethylene or mixtures composed substantially of polyethylene. As a result, each core 60 is extremely soft having a durometer of less than or equal to about 70 Shore D and nominally less than or equal to about 50 Shore D. Because each core 60 has a durometer of less than or equal to about 70 Shore D, cores 60 better clamp or anchor to a fitting of hose connectors 52, 54.

In other embodiments, each core 60 may be formed from other flexible polymeric materials. For example, in other embodiments, each of cores 60 may be formed from the SANTOPRENE family of thermoplastic rubbers or other polymeric materials. Although hose 50 is illustrated as it including two cores 60, in other embodiments, hose 50 may include greater than two cores, wherein the fluid passages or conduits of each of the cores 60 merge, join or connect to one another immediately at opposite ends of hose 50, such as in a fluid passage connected to all of such conduits.

Reinforcements 62 each comprise an elongate tubular braided filament or sheath of interwoven strands of reinforcing fibers material encircling its associated core 60. Reinforcements 62 strengthen each of cores 62 and further reduce or inhibit potential stretching and damage to jacket 64 which might otherwise occur in the absence of one or both of reinforcements 62 when cores 60 are delivering fluid under high pressures such as fluid at pressures greater than 100 psi. According to one embodiment, each of reinforcements 62 comprises a braided filament or sheathing formed from one of more polymers, steel filaments, glass filaments, carbon filaments, polyester filaments, filament yarns or other filaments which may be organic or mineral-based. According to one embodiment, the filaments have a tenacity of between about 802 about 900 mN to about 100N. One example of a certain filament from which reinforcements 62 may be formed comprises a high-tenacity polyester filament yarn sold under the trademark DIOLEN 183. According to one embodiment, each of reinforcements 62 is braided at an angle of at least 1.41 and nominally within a range of between about 1.41 and 1.48. In one such embodiment, reinforcements 62 each have a thickness ranging from about 1.0 to about 1.3 mm on a round yarn.

In the example illustrated, each of reinforcements 62 is actually simply secured to its associated core 60. In one embodiment, reinforcements 62 are adhesively bonded to core 60 using an appropriate adhesive such as a urethane or acrylate adhesive. The adhesive provides sufficient adhesive strength to inhibit separation of cores 60 from their respective reinforcements 62 when hose 50 is bent. In other embodiments, reinforcements 62 may be secured to core 60 in other manners.

Although reinforcements 62 are illustrated as comprising tubes of a braided sheet or filament encircling each of the respective cores 60, in other embodiments, reinforcements 62 may be replaced with other reinforcement structures or arrangements. For example, rather than having two reinforcement layers or portions between cores 60A and 60B, a single reinforcement layer portion may alternatively be sandwiched between cores 60A and 60B. In such embodiment, cores 60A and 60B would share a single reinforcement layer sandwiched between such cores 60. In such an embodiment, hose 50 may alternatively have a single reinforcement structure having a shape of an “8”.

Jacket 64 comprises at least one layer of flexible material continuously extending about cores 60 and reinforcements 62. Jacket 64 further interconnects or joins cores 60 and they are associated reinforcements 62. Jacket 64 protects reinforcements 62 from abrasion and maintains cores 60 in close proximity to facilitate enhanced handling and management of hose 50.

According to one embodiment, jacket 64 is formed from a flexible abrasion resistant material such as vulcanized rubber. In other embodiments, jacket 64 may be formed from other flexible polymeric materials such as those selected from the SANTOPRENE family of thermoplastic rubbers or other polymeric materials. In the example illustrated, jacket 64 had a thickness of between about 1 and 1.2 mm.

According to one embodiment, jacket 64 is formed about and adhesively secured to reinforcements 62. Jacket 64 is adhesively secured to reinforcements 62 with sufficient adhesive strength to inhibit separation of jacket 64 from reinforcements 62 when hose 50 is bent. In one embodiment, Jacket 64 is bonded to reinforcements 62 using adhesive substantially similar or identical to the adhesive used to secure reinforcements 62 to cores 60. In yet other embodiments, jacket 64 is molded about both cores 60 and reinforcements 62. In such an embodiment, the polymeric material or materials of jacket 64 flow about, through and infiltrate the filament in of reinforcements 62 to encapsulate reinforcements 62. In some embodiments, the one of more polymeric materials of jacket 64 may fuse to the outer circumference show surfaces of cores 60. As a result, hose 50 may be stronger and more resistant to separation during bending of hose 50.

In the example illustrated, hose 50 has a minimal bend radius less than or equal is to about 38 mm and nominally no greater than 36 mm. In one embodiment, hose 50 has a minimum bend radius of no greater than 32 mm. The minimum bend radius is determined by banning the hose with no fluid contained therein over an angle of 180 degrees and reducing the size of the bend in the small a diameter as possible without taking the hose. The minimum bend radius may further be defined as the distance between the central bend line of the bent portion of the hose in the center the hose, wherein the distance is measured along an angle normal to the bent line.

According to one embodiment, hose 50 has a burst ratio of at least 2 to 1 and nominally at least 3 to 1. The burst ratio is the ratio of the pressure at which a conduit of the hose will burst to the pressure rating for the hose. According to one embodiment, hose 50 has a burst pressure of at least 8000 psi. In other embodiments, hose 50 may have other bend radiuses and burst pressures.

Overall, hose 50 provides multiple fluid passages or vesicles for delivering fluid under relatively high pressures from a single source to a single recipient. The multiple fluid passages of hose 50 have a sufficient collective cross-sectional area to sufficiently deliver fluid at a rate equivalent or greater than a an alternative hose having a single fluid passage. At the same time, hose 50 is smaller to coil up for storage and may offer better kink resistance than such single passage round hoses. Because between each of the multiple fluid passages, the intermediate layers between the fluid passages are less likely to tear or permanently deform upon encountering such high pressures and forces and are better able to maintain their shape.

In one specific example embodiment, each of cores 60 has a radius of between about 3.75 mm and 3.83 mm. Reinforcements 62 each have a thickness of between about 1.0 and 1.3 mm. Jacket 64 has a thickness about reinforcements 62 of between about 1.0 mm and 1.2 mm. As a result, core 60A, reinforcements 62A and the surrounding jacket 64 had a radius of between 5.75 mm and 6.33 mm. Core 60B, reinforcements 62B and its surrounding jacket have a similar minimum and maximum radius. A corresponding single passage hose capable of delivering fluid at the same rate and at the same pressure would alternatively have a radius of 7.3 mm. As compared to such a single passage hose, hose 50 offers a 10% to 12% reduction in height. This lower height or flatter shape facilitates hose 50 being more compactly coiled and wound up when not in use.

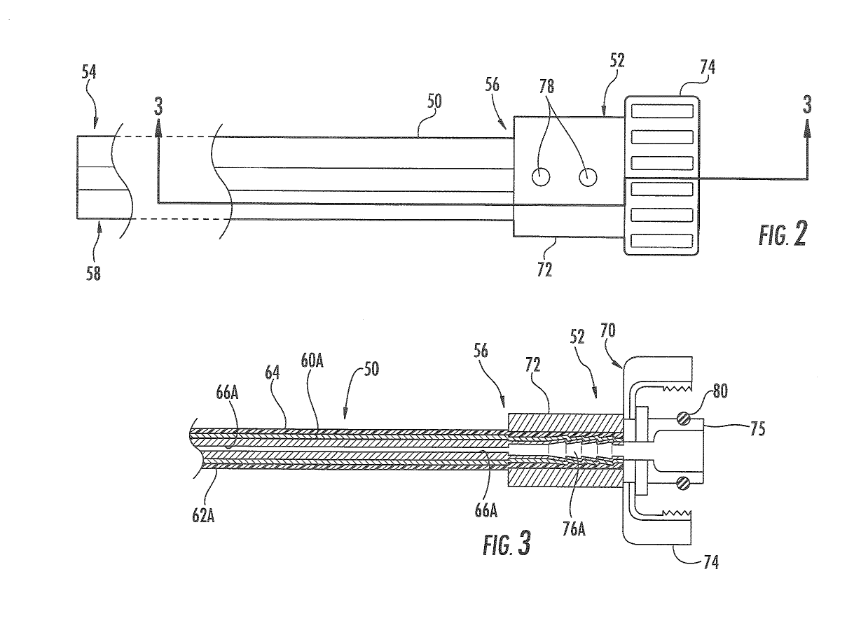

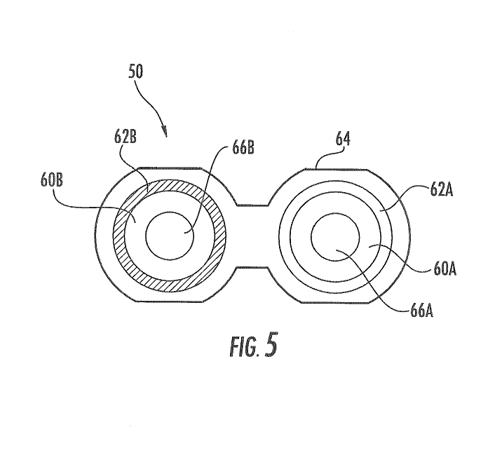

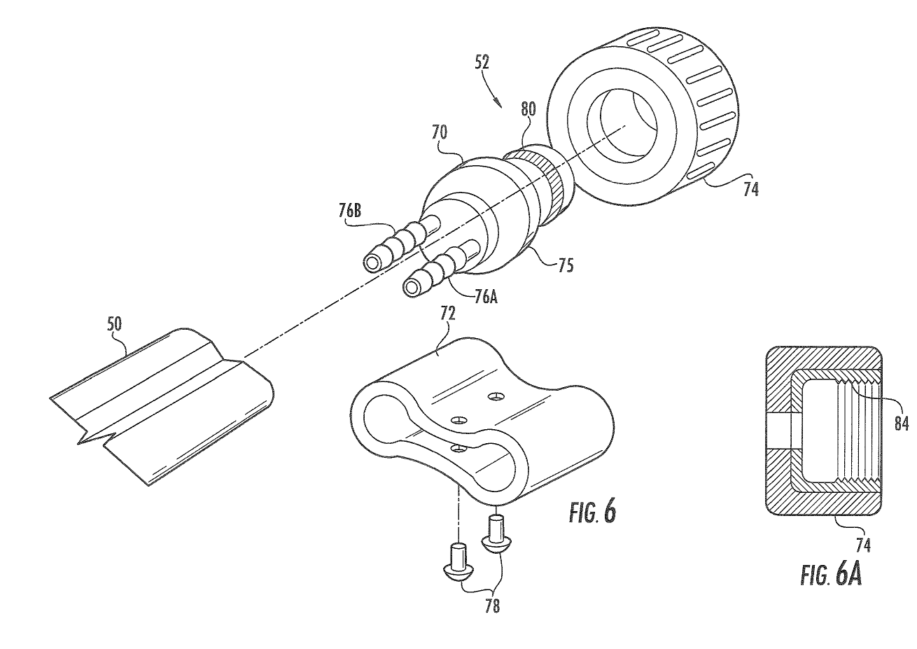

As shown by FIGS. 3 and 6, hose connector 52 is joined to an end of hose 50 and facilitates securement of hose 50 to pump 34 (shown in FIG. 1). Hose connector 54 (shown in FIG. 2) has a construction similar to or identical to hose connector 52 and is joined to an opposite end of hose 50. Hose connector 54 secures hose 50 to spray gun 26 (shown in FIG. 1).

As shown by FIG. 6, hose connector 52 includes fitting 70, clamp 72 and hose coupler 74. Fitting 70 joins hose 50 to hose coupler 74 and includes a main body 75 and a number of hollow rods 76 corresponding to the number of conduits 66 of hose 50. Body 75 supports rods 76 and provides a single chamber, cavity, lumen or fluid passageway joined to be in hollow interiors of all of rods 76. Body 75 is further configured to facilitate connection of fitting 70 to hose coupler 74.

Hollow rods 76 extend from body 75 into hose 50 to facilitate connection of hose 50 to fitting 70. In the example illustrated, fitting 70 includes two hollow rods 76A and 76B. As shown by FIG. 3, rods 76 have at least portions with outer diameters larger than an inner diameter of conduits 64. As a result, when rod 76 are inserted into conduits 66, cores 60 resilient stretch to accommodate rods 76 and to form a fluid tight seal against rods 76. As noted above, because cores 60 are formed from a relatively soft polymer, such as polyethylene, in one embodiment, the seal and retention of hose 50 upon rods 76 may be more reliable. Fluid flowing within conduits 66 flows through rods 76 into the interior of body 70.

Clamp 72 comprise one of our structures configured to extend about hose 50 opposite to rods 76 so as to sandwich portions of hose 50 between rods 76 and clamp 72. In the example illustrated, clamp 72 utilizes fasteners, such as rivets 78, to compress clamp 72 about an exterior of hose 50, wherein the end of hose 50 is squeezed against rods 76 to further enhance the fluid seal between hose 50 and rods 76. In other embodiments, a releasable or adjustable clamp may be utilized. In still other embodiments, clamp 72 may be omitted.

Hose coupler 74 comprises a structure configured to be mounted to body 70 and to facilitate connection of hose assembly 30 to source 24 or pump 34 (shown in FIG. 1). Likewise, the hose coupler 74 of hose connector 54 is configured to facilitate connection of hose assembly 32 spray gun 26 (shown in FIG. 1). In the example illustrated, hose coupler 74 is joined to body 70, where the fluid seal is provided by an elastomeric O-ring 80. As shown by FIG. 6A, hose coupler 74 further includes an internally threaded cavity 84 configured to be threaded onto a corresponding externally threaded outlet of pump 34. In other embodiments, hose coupler 74 may be joined to body 70 and may be configured to be connected to pump 34 (or spray gun 26 in the case of connector 54) in other manners. For example, in other embodiments, hose coupler 74 may alternatively comprise a quick disconnect connector. In yet other embodiments, one or both of hose connectors 52, 54 may have other configurations.

FIGS. 7-13 are cross sectional views of multi-fluid passage hoses 150-750, alternative embodiments of hose 50. Each of the alternative hose as shown in FIGS. 7-13 provides multiple fluid passages which collectively gather into a single chamber immediately or substantially immediately at each end of the hose. In such embodiments, the connectors 52, 54 at opposite ends of the hose have a number and arrangement of hollow rods 76 corresponding to the number and arrangement of conduits of the hoses. As with hose 50, each of the hoses shown in FIG. 7-13 offers a hose that is less susceptible to kinking and that may be more compactly coiled up when not in use.

FIG. 7 illustrates hose 150. Hose 150 is similar to hose 50 except that hose 150 includes an additional core 60C providing a third conduit 66C and an additional reinforcement 62C. Hose 150 has a jacket 164 which encloses, encircles and interconnects all three sets of cores and reinforcements in a serial, linear arrangement.

FIG. 8 illustrates hose 250. Hose 250 is similar to hose 150 except that hose 250 has a jacket 264 enclosing, encircling and interconnecting four sets of cores and reinforcements. Jacket 264 retains the four sets of cores and reinforcements in a serial arrangement or relationship, wherein the centers of conduits 66 are located along a single linear line.

FIGS. 9 and 10 illustrate alternative versions of hose 250 in which the centers of conduits 66 of the four sets of cores and reinforcements have alternative arrangements to provide such hoses with alternative shapes for greater compactness when such hoses are being coiled up or for ease of bending or manipulation, without twisting, during use. FIG. 9 illustrates hose 350 having a jacket 364 retaining the four sets of cores and reinforcements in an arcuate shape. FIG. 10 illustrates hose 450 having a jacket 464 retaining the four sets of cores and reinforcements in an arrangement such that the end most sets of cores and reinforcements are angled in opposite directions with respect to the two intermediate sets of cores and reinforcements.

FIG. 11 illustrates hose 550. Hose 550 is similar to hose 150 except that each set of core 60 and reinforcement 62 is adjacent both of the other sets of cores 60 and reinforcement 62. In the example illustrated, hose 550 includes jacket 564 retains the three sets of cores 60 and reinforcements 62 in a pyramidal or triangular arrangement. As a result, the arrangement of cores 60 and reinforcements 62 is more compact. Moreover, because each core 60 shares reinforcements 62 with at least two other cores 60, this arrangement may result in a stronger overall hose.

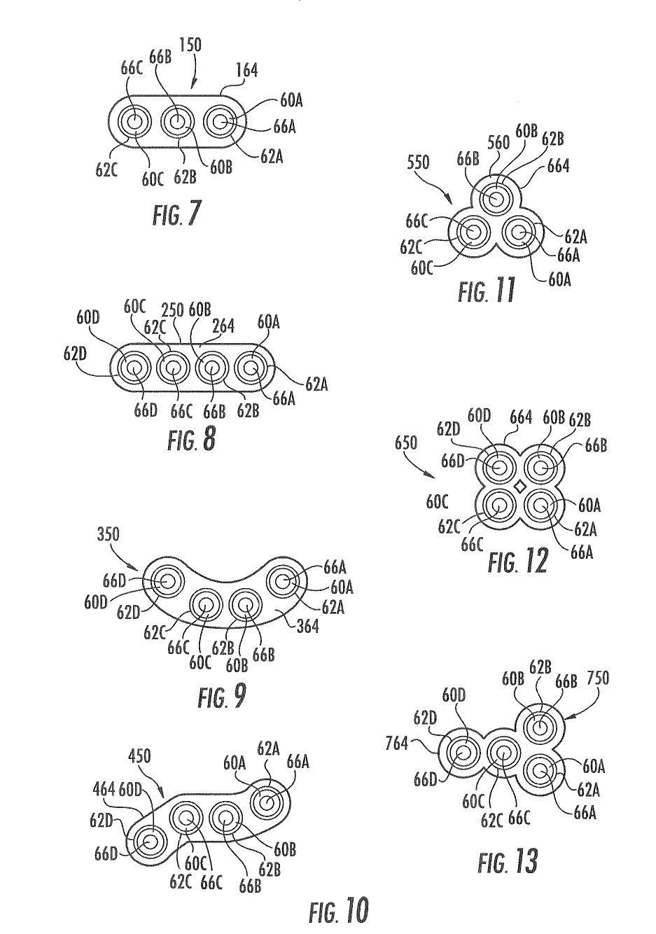

FIG. 12 illustrates hose 650. Hose 650 includes a jacket 664 which retains four sets of cores 60 and reinforcement 62 in a four-sided, square arrangement. As with hose 550, this arrangement of cores 60 and reinforcements 62 is more compact. Moreover, because each core 60 shares reinforcements 62 with at least two other cores 60, this arrangement may result in a stronger overall hose. Hose 650 offers four substantially planer flat sides, facilitating more compact or easier coiling of hose 650 as compared to hose 550.

FIG. 13 illustrates hose 750. Hose 750 includes jacket 764 which retains the four sets of cores 60 and reinforcements 62 in a T-shaped arrangement. In hose 750, three of the sets of cores 60 and reinforcement 62 share multiple reinforcements. Although hoses 350-750 include either three or four sets of cores 60 and reinforcements 62, in other embodiments, the hoses may have greater than four sets of cores 60 and reinforcements 62 arranged in either serial fashions as shown in FIGS. 7-10 or in clustered fashions shown in FIGS. 11-13.

Although the present disclosure has been described with reference to example embodiments, workers skilled in the art will recognize that changes may be made in form and detail without departing from the spirit and scope of the claimed subject matter. For example, although different example embodiments may have been described as including one or more features providing one or more benefits, it is contemplated that the described features may be interchanged with one another or alternatively be combined with one another in the described example embodiments or in other alternative embodiments. Because the technology of the present disclosure is relatively complex, not all changes in the technology are foreseeable. The present disclosure described with reference to the example embodiments and set forth in the following claims is manifestly intended to be as broad as possible. For example, unless specifically otherwise noted, the claims reciting a single particular element also encompass a plurality of such particular elements.

What is claimed is:

1. An apparatus comprising:
a hose comprising:
a first tubular core having a first conduit opening into a first passage at a first end of the first conduit and opening into a second passage at a second end of the first conduit;
a second tubular core having a second conduit opening into the first passage at a first end of the second conduit and opening into the second passage at a second end of the second conduit;
a first reinforcement sandwiched between the first tubular core and the second tubular core; and
a jacket extending about and interconnecting the first tubular core and the second tubular core.

2. The apparatus of claim 1, wherein the first reinforcement including a first braiding of filaments.

3. The apparatus of claim 2, wherein the jacket comprises one or more polymeric materials encapsulating the first braiding of filaments.

4. The apparatus of claim 2, wherein the first reinforcement further encircles the first conduit.

5. The apparatus of claim 1, wherein the first reinforcement further encircles the first conduit.

6. The apparatus of claim 1 further comprising a second reinforcement sandwiched between the first tubular core and of the second tubular core.

7. The apparatus of claim 6, wherein the first reinforcement comprises a first braiding of filaments and wherein the second reinforcement comprises a second braiding of filaments.

8. The apparatus of claim 7, wherein the jacket comprises one or more polymeric materials encapsulating the first braiding of filaments and the second braiding of filaments.

9. The apparatus of claim 8, wherein the second reinforcement further encircles the second conduit.

10. The apparatus of claim 6, wherein the second reinforcement further encircles the second conduit.

11. The apparatus of claim 1 further comprising an outlet hose connector connected to the first end of the first conduit and the second end of the second conduit, the outlet hose connector forming the first passage.

12. The apparatus of claim 11 further comprising an inlet hose connector connected to the second end of the first conduit and the first end of the second conduit, the inlet hose connector forming the second passage.

13. The apparatus of claim 1 further comprising:
a spray gun having a discharge nozzle;
a source of fluid at a pressure of at least 100 psi at the discharge nozzle.

14. The apparatus of claim 13, wherein the source of fluid comprises a pressure washer.

15. The apparatus of claim 1 further comprising:
a third tubular core having a third conduit opening into the first passage at a first end of the third conduit and opening into the second passage at a second end of the third conduit; and
a second reinforcement sandwiched between the second core and the third core, wherein the jacket extends about and interconnects the first tubular core, the second tubular core and the third tubular core.

16. The apparatus of claim 15 further comprising a third reinforcement sandwiched between the first core and the third core.

17. The apparatus of claim 15 further comprising:
a first tubular braiding of filament about the first core and providing the first reinforcement;
a second tubular braiding of filament about the second core and providing the second reinforcement; and
a third tubular braiding of filament about the third core and providing the third reinforcement.

18. The apparatus of claim 15, wherein the first tubular core, the second tubular core and the third tubular core are arranged in series.

19. A pressure washer comprising:
a spray gun having a discharge nozzle;
a source of pressurized fluid at a pressure of at least 100 psi at the discharge nozzle;
a hose connecting the spray gun to the source of pressurized fluid, the hose comprising:
a first tubular core having a first conduit opening into a first passage at a first end of the first conduit and opening into a second passage at a second end of the first conduit;
a first tube with her braiding about the first tubular core;
a second tubular core having a second conduit opening into the first passage at a first end of the second conduit and opening into the second passage at a second end of the second conduit;
a second tubular braiding about the second core; and
a continuous integral jacket encapsulating the first tubular braiding and the second tubular braiding.

20. A method for making a pressure washer hose, the method comprising:
forming a first to be liberating about a first tubular core providing a first conduit having a first end and a second end;
forming a second tubular braiding about a second tubular core providing a second conduit having a first end and a second end;
forming a first hose connector at the first end of the first conduit and at the second end of the second conduit, the first hose connector having a passage joining the first conduit and the second conduit;
forming a jacket continuously extending about the first tubular core and the second tubular core, the jacket encapsulating the first tubular braiding and the second tubular braiding.
